(19) United States
(12) Patent Application Publication
(10) Pub. No.: US 2012/0246939 A1
(43) Pub. Date: Oct. 4, 2012

(54) Integrated Panelization

(75) Inventors: Daniel Maston Odom, Maryville, TN (US); William Patrick Odom, Maryville, TN (US)

(73) Assignee: Odom Construction, Knoxville, TN (US)

(21) Appl. No.: 13/437,367

(22) Filed: Apr. 2, 2012

Related U.S. Application Data
(60) Provisional application No. 61/470,858, filed on Apr. 1, 2011.

(51) Int. Cl. B23P 17/00; B21D 31/00; B21D 5/08

(52) U.S. Cl. 29/897.32; 72/127; 72/129

(57) ABSTRACT

An integrated method and system for producing cold-formed steel wall, roof, and/or floor panels is disclosed. Included in the present general inventive concept is the input of design parameters into a computer having design software operating thereon, the generation of design decisions based on those parameters, the issuance of fabrication instructions to one or more roll formers to fabricate the panel components substantially according to those fabrication instructions, and the fabrication of the panel components by the roll formers substantially in accordance with the fabrication instructions.

### CROSS-REFERENCE TO RELATED APPLICATIONS

This application claims the benefit of U.S. Provisional Patent Application No. 61/470,858, filed on Apr. 1, 2011, and incorporates by reference the contents herein.

### FIELD OF INVENTION

The present inventive concept relates generally to the production of structural support panels, and more particularly, to an integrated method and system that coordinates the design, fabrication, and erection of steel-frame panels.

### BACKGROUND

The production of cold-formed steel panels for use in constructing wall, roof, and floor supports is known in the art. Such panels can be used to erect arrangements for stand-alone structures, or can be incorporated into existing structures during renovations. Wall panels may generally be comprised of vertical studs and horizontal tracks, and typically have to be designed for the specific job to accommodate load requirements, desired locations for openings, and other engineering, architectural and design concerns.

Traditionally, when a project requires the installation of panels, a builder prepares their own drawings by hand or with computer drafting software and then engages third party engineers to review the sizing and detailing of the members. Alternatively, the builder may sub-contract out all of the drawing, sizing, and detailing work to a third-party firm. Third-party firms can be independent, but are frequently affiliated with major stud manufacturers. Therefore, this stage of the process may impose limitations on the options of choosing certain manufacturers, sizes and processes of fabrication.

After the drawings receive approval, the panels are fabricated. This may be accomplished directly by the builder, or the builder may solicit another firm or labor service to fabricate the panels. Frequently, the practices utilized for the fabrication, such as “chop-sawing,” are often expensive. Additionally, the risk that the individuals involved in the fabrication process will not be adequately trained or supervised with regard to quality control is present.

After the panels are fabricated, they are installed. This too can either be performed by the builder or by a third party labor service, and the same concerns about adequate training, supervision, and quality control still exist.

In light of the above, multiple independent firms may affect the design, layout, sizing, fabrication, proper installation of anchorage as directed by the shop drawings, and acceptable installation tolerances for the panels. Accordingly, there exists a need for a paneling method and system that integrates each stage of the process to deliver a customized panel product for the particular job order. More specifically, there exists a need for a method or system that combines a variety of technologies, including design and drafting software, fabrication machinery, panel assembly, packaging and delivery, installation, and inspection/warranty.

### BRIEF SUMMARY

The present general inventive concept provides an integrated panel method and system that can simultaneously deliver customized, pre-assembled panels, knockdown kits, and/or sequenced components of the same with single-point accountability and job-specific flexibility.

In accordance with various embodiments of the present general inventive concept, a method of producing wall, floor, and/or roof panels may include inputting design parameters for a project into a computer having design software operating thereon; processing the design parameters by the computer to make design decisions regarding panels and panel components directed to the project; outputting fabrication instructions from the computer to one or more roll formers for each of the panel components, the fabrication instructions being substantially derived from the design decisions; and fabricating the panel components by the one or more roll formers according to the fabrication instructions, the fabricating being bifurcated such that selected panel components are fabricated either as a knockdown kit or as a pre-assembled panel grouping.

In various embodiments, the method can further include assembling preassembled panels from the selected preassembled panel grouping components.

In various embodiments, the method can further include packaging and transferring the selected knockdown kit panel components and the preassembled panels to the project's location.

In various embodiments, the method can further include installing the knockdown kit panel components and the preassembled panels at the project location.

In various embodiments, the design parameters may include a preferred sequence of panel installation, and the design decisions may include a sequence of fabrication derived substantially from the preferred sequence of panel installation.

In various embodiments, the design parameters may include load requirements of the project, type of panels called for by the project, maximum panel size, location of the panels within the project, the size and location of openings within the project, or any combination thereof.

In various embodiments, the design decisions may include the positioning of one or more interaction options on selected panel components, the fabrication instructions may include the positioning of one or more interaction options on the selected panel components, and the fabricating of the panel components may include the placement of one or more interaction options on the selected panel components.

In various embodiments, the one or more interaction options may include complementary dimples, slotted grooves, or a combination thereof.

In various embodiments, the design decisions may include designating selected panel components as a knockdown kit or as a preassembled panel grouping.

In various embodiments, the fabricating of the panel components by the one or more roll formers includes the one or more roll formers physically marking all four sides of selected panel components with intelligent indicia.

In various embodiments, the intelligent indicia may include the component's panel designation, a location within the project of the panel that includes the component, the component's location within the panel, the positioning of one or more openings in the project relative to the panel component, the identification of the coil spool from which the panel component was fabricated, or any combination thereof.

In accordance with various embodiments of the present general inventive concept, a method of producing a cold-formed steel panel for inclusion into a structural frame may include inputting design parameters for a project into a computer having design software operating thereon, the design parameters including a preferred sequence of installing panels in the project, load requirements of the project, type of panels called for by the project, maximum panel size, location of the panels within the project, the size and location of openings within the project, or any combination thereof; processing, by the computer, the design parameters to make design decisions, the design decisions including the number of panels required by the project, a sequence of fabrication for panel components that is substantially derived from the preferred sequence of panel installation included in the design parameters, the design decisions further including the positioning of one or more interaction options on two or more selected panel components; outputting fabrication instructions from the computer to one or more roll formers, the fabrication instructions being substantially derived from the design decisions, the fabrication instructions including the sequence of fabrication, the positioning of one or more interaction options on two or more selected panel components, commands for the one or more roll formers to physically mark all four sides of selected panel components with intelligent indicia; fabricating the panel components by the one or more roll formers, the fabrication occurring substantially in sequence according to the fabrication instructions and including the placement of one or more interaction options on two or more selected panel components and the physical marking of intelligent indicia onto all four sides of the selected panel components; and assembling the panel components to form a panel such that assembly is performed in sequence substantially according to the sequence of fabrication, and contiguous panel components are engaged by mating the interaction options.

In various embodiments, the intelligent indicia may include the panel component's panel designation, a location within the project of the panel that includes the component, the panel component's location within the panel, the positioning of one or more openings relative to the panel component, the identification of the coil spool from which the panel component was fabricated, or any combination thereof.

In various embodiments, the computer processing the design parameters to make the design decisions may include determining whether the panel components are to be fabricated as part of a knockdown kit or as part of a preassembled panel grouping, the outputting of fabrication instructions to one or more roll formers may include designating each panel component to be fabricated as part of a knockdown kit or as part of a pre-assembled panel grouping, the fabricating of panel components may include bifurcating fabrication such that the panel components are selectively fabricated either as part of a knockdown kit or as a preassembled panel grouping.

In accordance with various embodiments of the general present inventive concept, a system to produce wall, floor, and/or roof panels may include a computer having design software installed and operable thereon to control the computer to receive design parameters for a project, process the design parameters using the design software to make design decisions, and generate fabrication instructions substantially according to the design decisions; and one or more roll formers to fabricate panel components, the one or more roll formers in communication with the computer to receive the fabrication instructions from the design software, the one or more roll formers fabricating the panel components substantially according to the fabrication instructions, the one or more roll formers including one or more modular tool sets that selectively alter selected panel components according to the fabrication instructions.

In various embodiments, the computer may receive design parameters for the project, the parameters may include a preferred sequence of installing panels in the project, load requirements of the project, type of panels called for by the project, maximum panel size, location of the panels within the project, the size and location of openings within the project, or any combination thereof.

In various embodiments, the computer processes the design parameters to make design decisions, the design decisions may include the number of panels required by the project, a sequence of fabricating the panel components that is substantially derived from the preferred sequence of panel installation included in the design parameters, the design decisions may further include the positioning of one or more interaction options on two or more selected panel components.

In various embodiments, the fabrication instructions are substantially derived from the design decisions, the fabrication instructions may include the sequence of fabrication, the positioning of one or more interaction options on two or more selected panel components, commands for one or more roll formers to physically mark all four sides of selected panel components with intelligent indicia, or any combination thereof.

In various embodiments, the intelligent indicia may include the component's panel designation, a location within the project of the panel that includes the component, the component's location within the panel, the positioning of one or more openings relative to the panel component, the identification of the coil spool from which the panel component was fabricated, or any combination thereof.

In various embodiments, the roll former may include one or more modular tool sets with a dimpling punch to place dimples on selected panel components, one or more modular tool sets with a V-shaped punch to place slotted grooves on selected panel components, and one or more modular tool sets with two or more print heads to physically mark all four sides of selected panel components with intelligent indicia, the one or more modular tool sets being interchangeable with one another.

Additional aspects and advantages of the present general inventive concept will be set forth in part in the description which follows, and, in part, will be obvious from the description, or may be learned by practice of the present general inventive concept.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a flow diagram of an example embodiment integrated panelization method, including panel design, fabrication, and installation;

FIG. 2 illustrates an exploded view of an example embodiment wall panel, which may be generated in accordance with the present general inventive concept;

FIG. 3 illustrates a partially-exploded view of the wall panel of FIG. 2;

FIG. 4 illustrates a partially-exploded view of the wall panel of FIG. 3, showing a close-up of contiguous panel components each bearing corresponding and complementary dimples, which may be generated in accordance with the present general inventive concept;

FIG. 5 illustrates a partially-exploded view of the wall panel of FIG. 4, including a close-up of engaged, example embodiment, contiguous panel components each bearing corresponding and complementary dimples;

FIG. 6 illustrates a partially-exploded view of an example embodiment wall panel, including a close-up of contiguous panel components, each bearing corresponding and complementary grooves and oblong holes, which may be generated in accordance with the present general inventive concept;

FIG. 7 illustrates an example embodiment roof panel wherein the contiguous components have been aligned using the indexing holes placed in each panel component;

FIG. 8 illustrates a diagram of an example embodiment roll former having modular tool sets installed thereon at selected locations;

FIG. 9A illustrates a side view of part of an example embodiment roll former having modular tool sets installed thereon at selected locations; and

FIG. 9B illustrates a side view of part of the example embodiment roll former of FIG. 9A, but having a different configuration of modular tool sets installed thereon.

### DETAILED DESCRIPTION

Reference will now be made to various example embodiments of the present general inventive concept, examples of which are illustrated in the accompanying drawings and illustrations. The example embodiments are described herein in order to explain the present general inventive concept by referring to the figures. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

In accordance with various embodiments of the present general inventive concept, a panel system and method is adapted to produce wall, roof, and/or floor panels from cold-formed steel. The panel system and method disclosed herein can provide solutions for panel generation beginning at project conception and ending at installation, inspection, and warranty issuance.

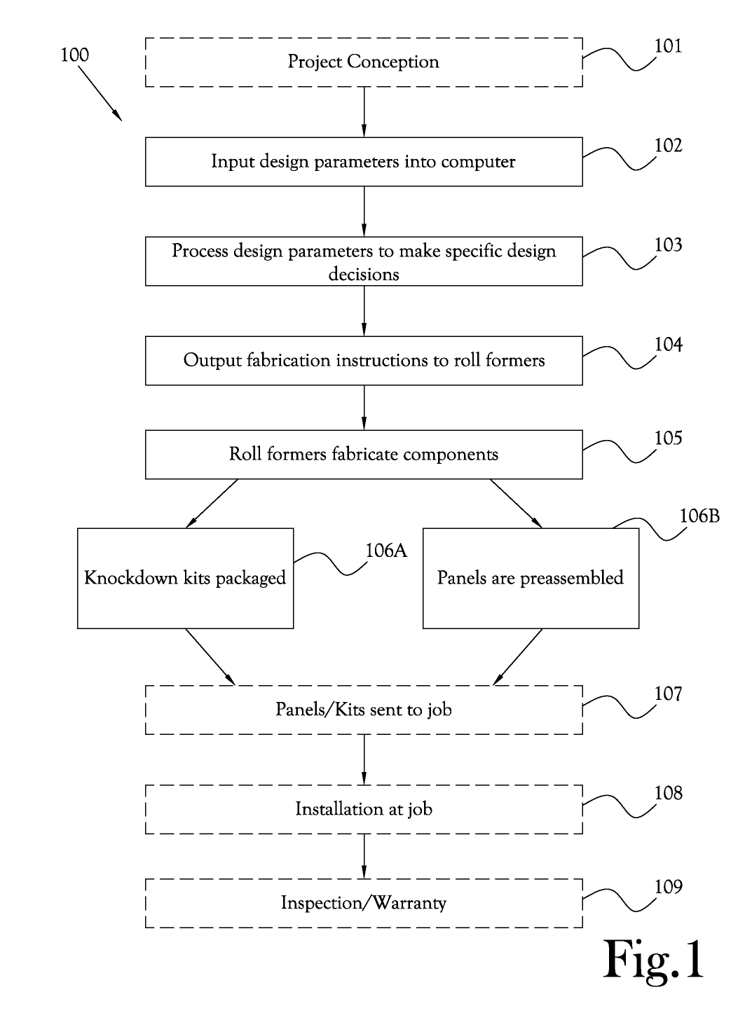

FIG. 1 portrays a flow diagram depicting the operation of a method 100 for designing, fabricating, and installing cold-formed steel panels into a project, according to various example embodiments of the present general inventive concept. In the illustrated embodiment, the method 100 includes project conception 101 (optional), the input of project geometry and/or information (design parameters) into a computer or like processing device having design software installed and operating thereon 102, the design software processing the parameters to generate specific design decisions 103, outputting fabrication instructions to roll formers 104, the roll formers fabricating panel components 105, packaging knockdown kits for delivery to a job site 106A, assembling pre-assembled panels prior to delivery to a job site 106B, delivering panels and/or kits to a job site 107 (optional), installing panels at a job site 108 (optional), and inspecting and/or warrantying the installed panels 109 (optional).

In accordance with various example embodiments of the integrated panelization method, a computer is provided having design software installed and operating thereon. Thus, individuals may interact with the software by entering commands and/or viewing design parameters, design decisions, and/or fabrication instructions on a standard computer with sufficient memory, processing capabilities, and storage space to run the particular design software. For the sake of reference in the instant application, “design software” and/or “computer” both refer to a computer or like processing device having design software operating thereon.

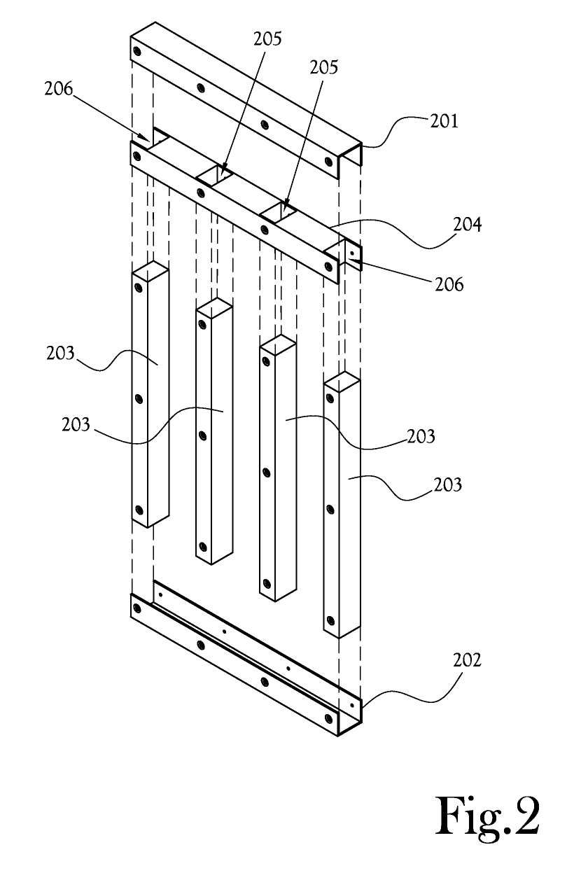

FIGS. 2-6 illustrate example embodiment panel assemblies that may be generated based on the design software's design decisions. The number, size, shape, spacing, location, style and interaction of the various panel components may be the result of the design parameters processed through the rule file of the design software.

FIG. 2 illustrates an exploded view of an example embodiment wall panel, which may be generated in accordance with the present general inventive concept. Vertical studs 203 are substantially straight members with opposing ends. Vertical studs 203 engage horizontal tracks 201, 202, and 204. In the illustrated embodiment, each vertical stud 203 within the panel is substantially the same size. The mid-span track 204 is likewise substantially straight, but with two opposing, yoke-shaped ends 206 to accommodate the registration of contiguous vertical studs 203 therethrough. The mid-span track 204 also accommodates vertical studs 203 with selectively placed through-holes 205 in the top and bottom faces of the track 204. The through-holes 205 are sized to accommodate the intimate registration of vertical studs therethrough. The top track 201 and bottom track 202 have U-shaped cross sections to accommodate the intimate registration of vertical studs 203 within the U-shaped channel. Stated differently, the dimensions of the U-shaped top and bottom tracks 201 & 202 are sized to accommodate the ends of the vertical studs 203 therein. In other embodiments, panel components may have a C-shaped cross section. Stated differently, panel components may generally include a U-shaped channel with flanges or lips partially overlapping both sides of the U-shaped channel. The present general inventive concept is not limited to producing panel components with any particular cross-sectional shape.

In the example embodiment illustrated in FIG. 2, each panel component is provided with interaction options at selected locations to accommodate the registration of contiguous panel components. Stated differently, each vertical stud 203 includes selectively placed interaction options that correspond to complementary, selectively placed interaction options on the mid-span track 204 and top and bottom tracks 201 and 202. Thus, the mid-span track 204 contains interaction options at each of its through-holes 205 and yoke-shaped ends 206 that complement the selectively placed interaction options on the vertical studs 203. Likewise, top track 201 and bottom track 202 each have selectively placed interaction options on their vertical faces that correspond to the position of each vertical stud received by the track. These interaction options mate with the interaction options on the vertical studs 203.

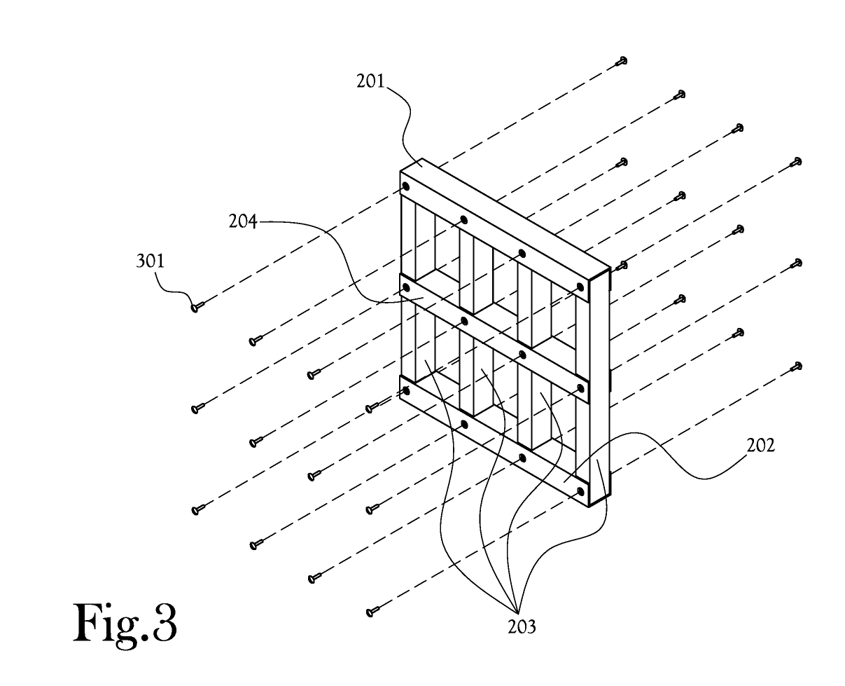

FIG. 3 illustrates a partially-exploded view of the wall panel of FIG. 2. Conventional connecting hardware 301 have been exploded in the present illustration. In the illustrated embodiment, the bolts 301 penetrate the contiguous panel components at the locations of the interaction options. Stated differently, each of the interaction options on the top track 201, bottom track 202, and mid-span track 204 have been mated with the corresponding interaction options of the vertical studs 203, and the bolts 301 penetrate both the horizontal track 201, 202, and 204, as well as the vertical stud 203 at the location of the mated interaction options. Conventional connecting hardware 301 may be used to secure contiguous components together, and may also include, but is not limited to, screws, powder-actuated fasteners, welding, or the like. The present general inventive concept is not limited to any particular type of connecting hardware 301.

The design software outputs the various instructions for the fabrication of the panel components to the roll formers, in accordance with various example embodiments of the present general inventive concept. Referring to FIGS. 2 & 3, the size, shape, and style of each vertical stud 203 and horizontal track 201, 202, and 204 may be dictated by the design guidelines in the software's rule file. Similarly, the placement and size of the through-holes 205 in the top and bottom faces of the mid-span tracks 204 may also be governed by the software's design guidelines, as may the particular cross-sectional dimensions of the top track 201 and bottom track 202. Furthermore, the styles and locations of all interaction options may be dictated by the design software.

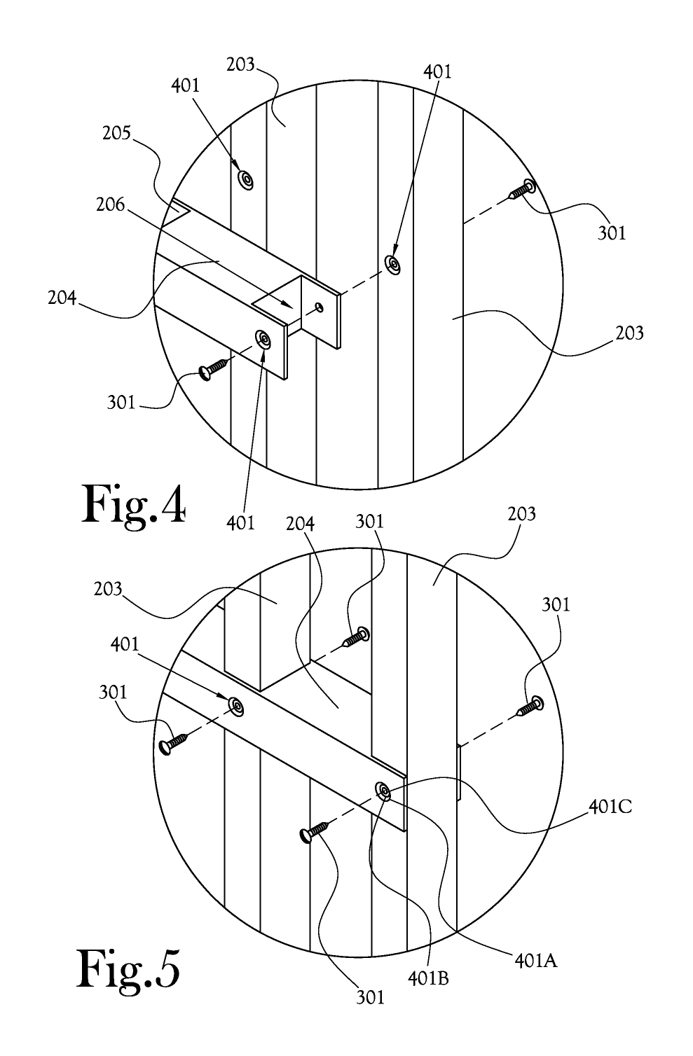

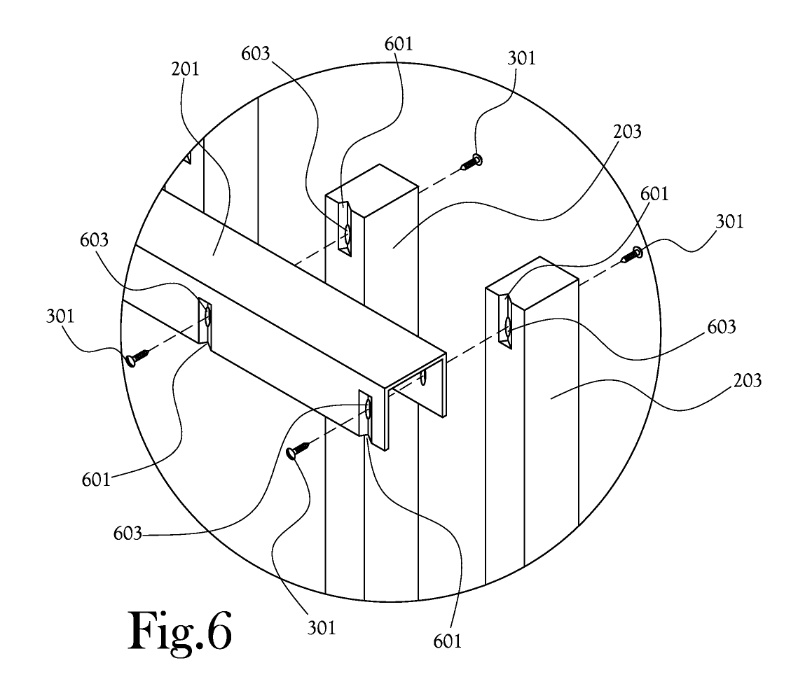

FIGS. 4-6 illustrate two examples of interaction options of the present general inventive concept. FIG. 4 illustrates a partially-exploded view of the example embodiment panel assembly of FIG. 3, wherein the contiguous components (vertical studs 203 and horizontal mid-span track 204) are provided with corresponding and complementary dimples 401 to facilitate their registration. FIG. 5 illustrates the partially-assembled example embodiment panel of FIG. 4, wherein vertical studs 203 are registered with a horizontal mid-span track 204 using corresponding and mating dimples 401. Dimples 401 are physical, circular indentations in the steel components that enable the registering of contiguous components and the receiving of conventional connecting hardware therethrough. Stated differently, each dimple 401 includes an indentation on one face of the component, and a protrusion on the opposing face. In the present example embodiment, concentric within the circular indentations of the dimples 401 are fastener holes that receive the conventional connecting hardware therethrough, as shown in the embodiments illustrated in FIGS. 4 and 5. Thus, in various embodiments, each dimple 401 may have three defined, concentric, circular perimeters: an outer rim of the indentation 401A, an inner rim of the indentation 401B, and the outer rim 401C of a fastener hole, as shown in FIG. 5.

In one embodiment, the dimples 401 are effectuated by a punch selectively directed to the face of a panel component during fabrication. Upon being punched, the receiving face becomes depressed to substantially conform to the punching member (e.g., a dimpling tool), while on the opposing face, a corresponding protrusion is effectuated. It will be understood that the present general inventive concept is not limited to the way in which the dimples are effectuated.

The selectively placed dimples 401 on the panel components specifically complement and mate with a corresponding dimples 401 on contiguous panel components. Contiguous components are registered by placing one component's dimple 401 against another component's dimple 401 to achieve a male-to-female mating connection, as depicted in FIG. 5. This may be achieved by corresponding and complementary dimples that are specifically sized such that the indentation of one dimple 401 accommodates the intimate registration of the protrusion of the other dimple 401.

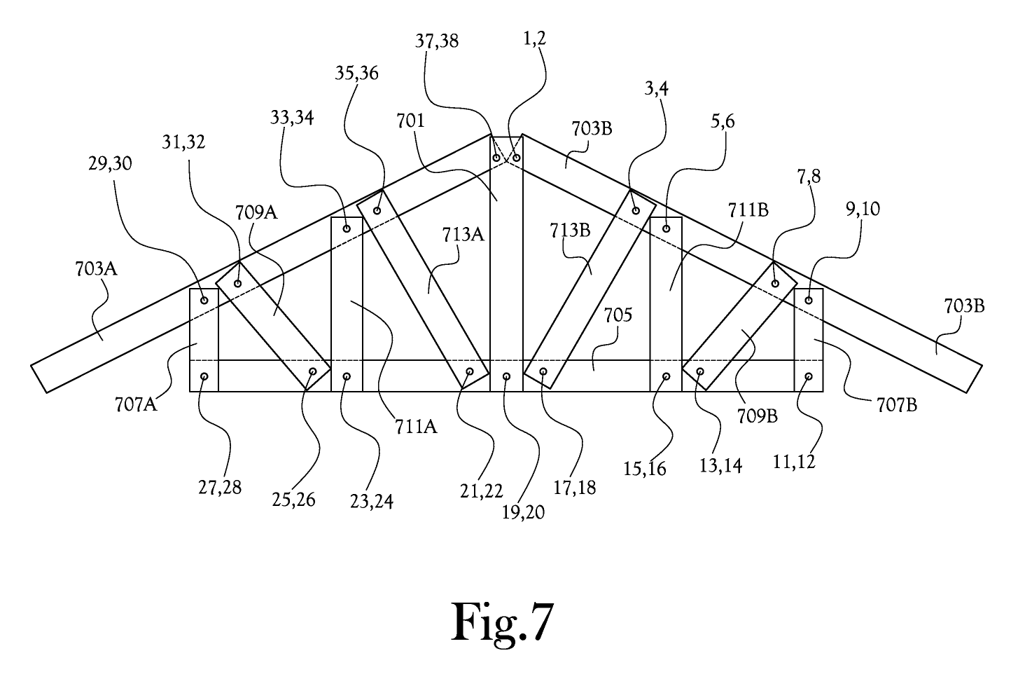

FIG. 6 illustrates a partially-exploded view of an example embodiment wall panel, including a close-up of contiguous panel components, each bearing corresponding and complementary slotted grooves and oblong holes, which may be generated in accordance with the present general inventive concept. In the illustrated embodiment, vertical studs 203 and horizontal top track 201 are registered together with corresponding slotted grooves and protrusions 601. In the illustrated embodiment, the horizontal top member 201 is provided with an elongated and recessed V-shaped groove on one face, as shown at 601, and a corresponding elongated V-shaped protrusion on the opposing face. In one embodiment, the slotted grooves/protrusions are one-half inch in depth, however, it will be understood by one of skill in the art that the present general inventive concept is not limited to grooves having a particular cross-sectional shape or depth.

In one embodiment, the V-shaped grooves and protrusions are effectuated by a punch selectively directed to the face of a panel component during fabrication. Upon being punched, the receiving face becomes depressed to substantially conform to the punching member (e.g., a V-shaped punch tool), while on the opposing face, a corresponding protrusion is effectuated. It will be understood that the present general inventive concept is not limited to the way in which the slotted grooves/protrusions are effectuated.

Contiguous panel components may be provided with corresponding and mating grooves/protrusions to accommodate the intimate registration thereof. In the illustrated embodiment, the slotted groove begins at the bottom edge of the vertical face of the horizontal top member 201, and extends toward the top of the vertical face, but without reaching the top of the vertical face. Correspondingly, the vertical stud 203 is punched in on one face, producing a complementary, elongated V-shaped groove on the punched face of the vertical stud 203. This slotted groove begins at the top of the vertical stud 203, and extends downward to accept the V-shaped protrusion 601 on the horizontal top member 201. The corresponding and complementary slotted grooves in the illustrated embodiment are specifically sized such that the protrusions in top track 201 intimately fit inside the grooves of the vertical studs 203. In one embodiment, the grooves/protrusions 601 are one and one-half inches in length. One of skill in the art will understand that the present general inventive concept is not limited to these particular dimensions and/or locations.

In various embodiments of the present general inventive concept, oblong holes 603 may be inserted into the slotted grooves/protrusions 601 to accept conventional connecting hardware 301 therethrough. In more detail, the panel components in FIG. 6 may have oblong holes 603 selectively positioned within the slotted grooves 601. Each oblong hole 603 in the illustrated embodiment spans a length of approximately one-half inch to one-inch, with sufficient width to accept a conventional connecting hardware unit 301 therethrough. However, one of skill in the art will recognize that the present general inventive concept is not limited to any particular dimension. Conventional connecting hardware 301 received through the oblong holes 603 and used to secure contiguous components together may include bolts, screws, powder-actuated fasteners, welding, or the like. The present general inventive concept is not limited to any particular type of connecting hardware 301.

The present example embodiment interaction option accommodates irregularity in wall height and also accounts for y-axis deflection that the panel components may experience after assembly and installation. Stated differently, the oblong holes 603 and the selective positioning of the slotted grooves 601 beginning at the top of the vertical studs 203 and the bottom of the vertical face of the top track 201 enable the top track 201, and any connected structure, to shift vertically with respect to the vertical studs 203, while still remaining intimately registered and secured to the vertical studs 203.

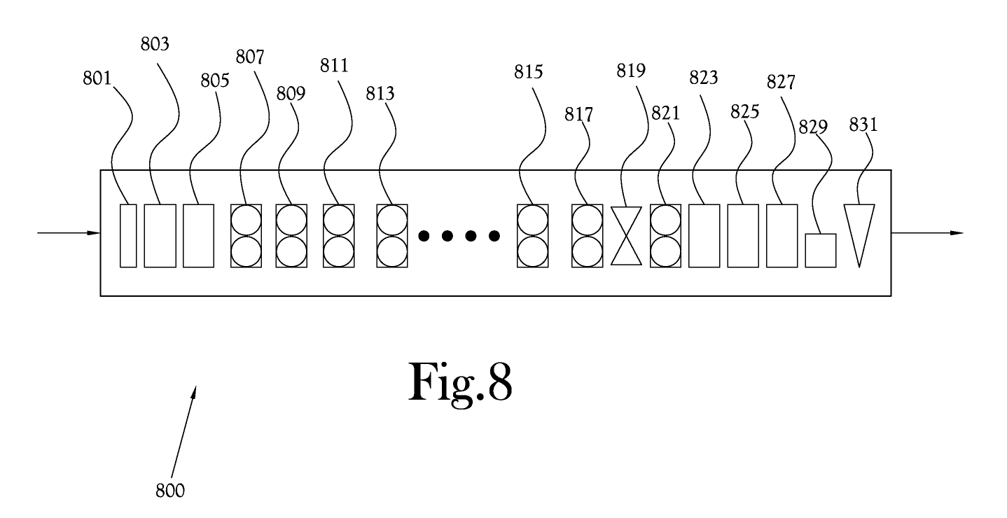

FIG. 7 illustrates an example embodiment roof panel 700 which may be generated in accordance with various embodiments of the present general inventive concept, wherein the contiguous panel components have been aligned using indexing holes that have been selectively placed in each component. In the illustrated example embodiment, vertical center member 701 is coupled to top chords 703A and 703B at one end, and to bottom chord 705 at the other end. Coupled to each end of bottom chord 705 are vertical end chords 707A and 707B, which are also coupled to top chords 703A and 703B. Interposing vertical center member 701 and vertical end chord 707A are diagonal member 709A, vertical member 711A, and diagonal member 713A, all of which are coupled to bottom chord 705 and top chord 703A. Likewise, interposing vertical center member 701 and vertical end chord 707B, are diagonal member 709B, vertical member 711B, and diagonal member 713B, all of which are coupled to bottom chord 705 and top chord 703B.

Indexing holes 1-38 in the illustrated embodiment are circular. However, one of skill in the art will understand that the present general inventive concept is not limited to circular indexing holes. Indexing holes may in fact be any shape. In another example embodiment, the indexing holes are triangular.

In the illustrated example embodiment, indexing holes 1-38 have been selectively placed in the panel components in order to aid in the assembly of the roof panel 700. Vertical center member 701 includes indexing holes 1 and 37 near one end, and indexing hole 19 near the opposing end. Top chord 703A includes indexing hole 38 near one end, as well as indexing holes 30, 32, 34, and 36 selectively positioned along its length. Likewise, top chord 703B includes indexing hole 2 near one end, and indexing holes 4, 6, 8, and 10 selectively positioned along its length. Bottom chord 705 includes indexing hole 28 near one end and indexing hole 12 near the opposing end, with selectively positioned indexing holes 26, 24, 22, 20, 18, 16, and 14 interposing indexing holes 28 and 12. Vertical end chord 707A includes indexing hole 27 located near one end and indexing hole 29 located near the opposing end. Diagonal member 709A includes indexing hole 31 near one end and indexing hole 25 near the opposing end. Vertical member 711A includes indexing hole 33 at one end and indexing hole 23 at the opposing end. Diagonal member 713A includes indexing hole 35 at one end and indexing hole 21 at the opposing end. Diagonal member 713B includes indexing hole 3 at one end and indexing hole 17 at the opposing end. Vertical member 711B includes indexing hole 5 at one end and indexing hoe 15 at the opposing end. Diagonal member 709B includes indexing hole 7 at one end and indexing hole 14 at the opposing end. Vertical end chord 707B includes indexing hole 9 at one end and indexing hole 11 at the opposing end.

The roof panel 700 may be assembled by aligning the corresponding indexing holes 1-38 that are present on the panel components. For instance, indexing hole 1 is located near the end of vertical center member 701 and corresponds with indexing hole 2, which is located near the end of top chord 703B. Indexing holes 1 and 2 correspond with one another and may be placed in a substantially overlapping fashion in order to properly position the top chord 703B with respect to vertical center member 701. In the example embodiment, indexing holes 1 and 2 are positioned such that the top chord member 703B may be properly positioned with respect to vertical center member 701, while not interfering with the proper positioning of top chord 703A with respect to vertical center member 701. Stated differently, indexing holes 1, 2, 37, and 38 are all selectively positioned on their respective panel components to allow both top chords 703A and 703B to properly register with vertical center member 701. In the illustrated example embodiment, top chords 703A and 703B are positioned such that they have substantially abutting corners.

In the illustrated example embodiment roof panel 700, indexing holes 3-6 are selectively positioned on their respective panel components to permit diagonal member 713B and vertical member 711B to properly register with top chord 703B. Diagonal member 713B and vertical member 711B are positioned such that they are in a substantially abutting relationship with one another. Likewise, indexing holes 7-10 are selectively positioned on their respective panel components to permit diagonal member 709B and vertical end chord 707B to properly register with top chord 703B. Diagonal member 709B and vertical end chord 707B are positioned such that they are in a substantially abutting relationship with one another. Similarly, indexing holes 13-16 are selectively positioned on their respective panel components to permit diagonal member 709B and vertical member 711B to properly register with bottom chord 705. Diagonal member 709B and vertical member 711B are positioned such that they are in a substantially abutting relationship with one another. Likewise, indexing holes 33-36 are selectively positioned on their respective panel components to permit diagonal member 713A and vertical member 711A to properly register with top chord 703A. Diagonal member 713A and vertical member 711A are positioned such that they are in a substantially abutting relationship with one another. Similarly, indexing holes 29-32 are selectively positioned on their respective panel components to permit diagonal member 709A and vertical end chord 707A to properly register with top chord 703A. Diagonal member 709A and vertical end chord 707A are positioned such that they are in a substantially abutting relationship with one another. Likewise, indexing holes 24-26 are selectively positioned on their respective panel components to permit diagonal member 709A and vertical member 711A to properly register with bottom chord 705. Diagonal member 709A and vertical member 711A are positioned such that they are in a substantially abutting relationship with one another.

Indexing holes 18-22 are all selectively positioned on their respective panel components to allow diagonal members 713A and 713B, as well as vertical center member 701, to properly register with bottom chord 705. Vertical center member 701 and diagonal members 713A and 713B are positioned such that both diagonal members 713A and 713B are in a substantially abutting relationship with vertical center member 701.

Conventional connecting hardware (not shown in the illustrated embodiment) may be used to secure contiguous components together. In one embodiment, conventional connecting hardware units are placed on each panel component substantially surrounding each indexing hole.

Returning to FIG. 1, in accordance with various embodiments of the present general inventive concept, an integrated panelization method 100 may optionally begin with the conception of a project 101 and the determination that the conceived-of project requires or accommodates wall, roof, and/or floor panels manufactured from cold-formed steel. It will be understood that that the operation of project conception may be performed in conjunction with the present general inventive method, or may also be performed prior to performing the present general inventive method.

In various example embodiments, an integrated panelization method may include inputting project geometry or specifications into a computer, as illustrated at 102 in FIG. 1. This operation may include the review of blueprints and project documents by drafting personnel. Stated differently, project information or design parameters entered into the computer may be generated by drafting personnel based off existing blueprints and project documents. Alternatively, drafting personnel may enter project geometry and specifications into the computer based off previous design parameters used to generate panels already in existence.

Examples of design parameters that may be entered into the design software may include project-specific information relating to the load requirements for the panels, the type of panels called for by the project, the maximum panel size and particular locations of certain panels within the project, the relationship of the panels with other project components, the size and location of doors, windows, hallways, and/or other openings, and/or the preferred order of panel installation. However, the present general inventive concept is not limited to the specific design parameters mentioned herein; one of skill in the art will understand that more or fewer design parameters may be input into the design software without departing from the scope or spirit of the present general inventive concept.

According to various example embodiments, the design software may process the design parameters through a rule file in order to make specific design decisions 103. Stated differently, the design software may gather the job-specific design information and process all of it through its rule file to generate specific design decisions and/or fabrication instructions for each panel and/or panel component. The rule file, which may be maintained in the design software, may include, but is not limited to, design guidelines for entire panels and/or various panel components relating to quantity, size, shape, spacing, location, style, interaction, and sequence of fabrication. The design parameters processed by the rule file's design guidelines may then be used to generate fabrication instructions that are eventually communicated to the roll formers, as shown at 104.

In one example embodiment, the design software may also permit individuals to review the design parameters processed by the design guidelines prior to the output of fabrication instructions to the roll formers. Stated differently, individuals may evaluate how the processed design parameters will be manifested in the fabricated panels and panel components before fabrication instructions are generated and sent to the roll formers. This allows for modification of the design parameters at an early stage of the process, before resources have been expended on undesirable design decisions. Upon modification of particular design parameters, the rule file may again process the modified parameters against the guidelines for review prior to generation of fabrication-specific instructions.

In accordance with various example embodiments of the present general inventive concept, the processing of the design parameters to make specific design decisions 103 may include identification of the various panel components. For instance, in various example embodiments, the design software may determine the number of panels required for each project and the location of the panels within the project, and may recognize and identify each individual panel component and the required dimensions, location of the components within the panel, style, and interaction options such as dimples or grooves. Additionally, the design software may group together related components so that fabrication occurs substantially in sequence according to a preferred order of panel installation included in the design parameters. Further, the design software may dictate which panel component is assigned to which roll former, in the event that the method utilizes a plurality of roll formers for fabrication. The design software also processes the order of fabrication, as submitted in the design parameters, to ensure that the panels will be fabricated in an order that will allow them to be stacked correctly for delivery to a job site and subsequent installation.

In one example embodiment, the design software may designate particular panels as either a pre-assembled panel or a knockdown kit. Stated differently, the fabrication of the panel components 105 may include bifurcating fabrication of the panel components. The roll formers may fabricate selected panel components as a group that are to be pre-assembled prior to being delivered to a job site, as illustrated in 106A. Alternatively, selected panel components may also be fabricated such that they are to be delivered to a job site un-assembled as part of a knockdown kit, as shown at 106B. In either case, the design software may designate particular components as being part of a pre-assembled panel grouping or a knockdown kit during the design decision-making 103 and/or the output of fabrication instructions 104. In one example embodiment, the design software may allow a user to manually designate the particular panels as knockdown kits or pre-assembled panels.

In one example embodiment, the design software may output reference drawings for panel assembly, which indicate the location of each fabricated component within an individual panel and that panel's position within the overall project. Further, the reference drawings may also contain a panel erecting sequence that will instruct individuals assembling and/or installing the panels of a proper order and/or method of assembly and/or installation. The reference drawings may also include information about groupings of panels and panel components, as well as directions on packaging and delivery sequence.

After the design parameters have been processed according to the design guidelines through the design software's rule file, the design software outputs fabrication instructions to the roll formers, as illustrated at 104, in accordance with example embodiments of the present general inventive concept. The fabrication instructions are the result of the specific design decisions made by the software in processing the design parameters. In one example embodiment of the present general inventive concept, the fabrication instructions include the specific cutting information for sizing each panel component, whether the particular component requires any interaction options such as dimples and/or grooves, the location and dimensions of any required interaction option(s), the location of any indexing holes, sequence of fabrication, groupings of panel components, whether the panel component is part of a knockdown kit or a preassembled panel grouping, and commands for the roll formers to mark each panel component with intelligent indicia (discussed further herein). However, the present general inventive concept is not limited to the above-mentioned, example fabrication instructions.

When the roll formers receive the fabrication instructions from the design software, they may begin fabricating the specific panel components, as illustrated at 105. The present general inventive concept may employ a single roll former to fabricate all of the panel components, or may use a plurality of roll formers to accomplish the same. In one example embodiment, panel component fabrication may be performed by three roll formers, and the design software may dictate which roll former fabricates each particular panel component. Stated differently, the design software may determine which panel components will be fabricated by each roll former during the design decision-making, and selectively transmit corresponding fabrication instructions for each of those panel components to the respective, selected roll former. In one example embodiment, the design software determines which panel components are assigned to which roll former based on the panel component's size.

According to various example embodiments of the present general inventive concept, the roll formers may be equipped with multiple print heads, dimpling tools, punches, and/or shears that allow for a variety of marks and alterations to be made to a component, as such targets are dictated by either the software's guidelines or the operator via the roll former's controller. In one example embodiment, the print heads, dimpling tools, punches, and/or shears are modular, interchangeable tool sets that may be removed and/or replaced as desired for fabrication of selected panel components. For instance, the roll formers may generate the particular interaction options as called for by the panel design by having installed thereon a modular tool set designed to make the particular interaction option. Stated differently, when a vertical stud is scheduled to engage with a contiguous horizontal track, the roll former's tool sets may effectuate the desired interaction option onto the contiguous panel components. Frequently, this will be the result of the software's rule file processing the design parameters against the design guidelines to determine the inclusion and placement of the particular interaction option, and including such determinations in the fabrication instructions transmitted to the one or more roll formers. The location of the interaction options may be fixed within the software, and/or may allow for operator modification to further define location criteria such as distance from the edge of a component, distance from the end of a wall or panel, or distance from an opening. Alternatively, an operator may dictate particular marks and/or alterations via the roll former's controller.

In various example embodiments, the one or more roll formers may be equipped with a modular tool set having multiple print heads to transfer intelligent indicia to the individual panel components. Intelligent indicia may include the component's group designation, panel location within the overall project, component location within the panel, information to identify the particular coil spool from which the component was fabricated, and/or other design locations such as the center point of an opening relative to the panel component, which may all be imprinted directly on each component, with such information corresponding to the reference drawings. Traditional methods may mark only the inside or outside of the webbing of a particular panel component, thus producing a mark that is frequently concealed from view during or after assembly. In various example embodiments of the present general inventive concept however, the modular tool sets equipped with one or more print heads may be positioned on the roll former such that they are able to mark up to four different sides of the component, thereby ensuring that the mark will be viewable during and after assembly. In one example embodiment of the present general inventive concept, horizontal track members are marked with intelligent indicia on all four sides, whereas vertical studs receive intelligent indicia on two sides. Marking the panel components with intelligent indicia expedites panel assembly and installation at the jobsite by providing the necessary information on each component to communicate that component's precise position within the panel and the overall project, as well as the relationship of that component with other contiguous components. This significantly aids the packaging, delivery, assembly, and installation processes by providing useful information directly on the panel components.

One example of how the marked intelligent indicia can expedite panel assembly is marking the center of window openings on the outside of a horizontal track's flange or lip. If the project has multiple floors, and the windows on each subsequent floor must line up with the ones above and below, these marks make it easy to accurately position the panels such that the center points of each window opening are consistent.

Another example of the advantage of the general present inventive concept includes the placement of matching index holes in contiguous components using a particular modular tool set included in the roll former. In one specific example embodiment, the present general inventive concept may place indexing holes in contiguous roof panel components. Traditionally, fabricators assemble panels by lining up contiguous components' indexing holes using labor intensive jigging. Jigging frequently consists of assembling a panel on top of a flat surface by securing stop blocks at selected locations according to the desired placement of each panel component. Necessarily, the stop block configurations must then be changed each time a different panel profile is to be assembled on the flat surface.

FIG. 7 illustrates an example embodiment roof panel wherein the contiguous components have been aligned using the indexing holes 1-38 placed in each panel component. The present inventive concept obviates the need for any jigging by defining the proper placement of the panel components with the indexing holes. The indexing holes may be used to align the panel components by overlapping contiguous components' corresponding indexing holes. The determination of where each indexing hole is placed may be made by the computer during the design decision-making, and may be included in the fabrication instructions transmitted to the one or more roll formers. The one or more roll formers may place the indexing holes in each selected panel component during fabrication.

Referring again to FIG. 1, in accordance with various example embodiments, the output stream of the roll formers (i.e., fabricated panel components) is bifurcated such that particular panel components are either packaged together as knockdown kits 106A or preassembled into panels 106B prior to delivery to the job site. In one example embodiment, fabrication of the panel components is bifurcated, such that knockdown kit components and preassembled panel components are fabricated separately.

Knockdown kits are the result of the software identifying a particular panel as suitable for job-site assembly and the one or more roll formers fabricating those panel components as a group. These components are then packaged together for delivery to a job site and subsequent assembly and installation. One example application of a knockdown kit is a situation in which a hotel or apartment structure calls for certain load-bearing walls and a plurality of similar interior units. All of the non-load-bearing walls within an interior unit, such as the bathroom, living room and hallways, may be prepared as knockdown kits, in accordance with an example embodiment of the present general inventive concept.

Alternatively, selected panels may be pre-assembled prior to their delivery to a job site, as shown at 106B. Typically, panels that are to be included in load-bearing walls may be pre-assembled and then delivered to a job site, ready for installation. Load-bearing wall panels are frequently pre-assembled because those panels can become stressed beyond a point at which conventional connecting hardware can support. Thus, welding may be required in addition to the conventional connecting hardware, and welding is typically done in a shop environment to assure that appropriate quality control measures are satisfied. Further, any desired sheathing and/or claddings may be applied to pre-assembled panels in shop, thus eliminating the need to do so on the job site.

Panel assembly may be manually performed. Using the design software's reference drawings, fabricators are able to select individual components using the intelligent indicia that have been transferred directly onto the components. Further, assembly and installation sequence also appear on the panel components and/or the reference drawings. Moreover, panel component fabrication has occurred substantially in sequence according to the preferred order of panel installation included in the design parameters.

Pre-assembled panels and knockdown kits may then be optionally collected and transferred to the job site for installation, as illustrated at 107, in accordance with an example embodiment of the present general inventive concept. Again, this frequently will occur over the course of several delivery trips, and the particular components and/or panels included in each delivery trip may be dictated by the assembly sequence, installation sequence, or delivery sequence, as provided by the design software. More specifically, the first panel fabricated will frequently be the last panel unloaded at the job site. In one example embodiment, this information may be part of the intelligent indicia that is physically imprinted on each individual panel component. It will be understood that the present general inventive concept may include the transferal of panels and panel components to a job site. Alternatively, the transferring of the panels and components to a job site may be done after performing the method of the present general inventive concept.

Once the knockdown kits and pre-assembled panels arrive at a job site, they are optionally assembled and/or installed, as illustrated at 108. Panel erection (assembly and/or installation) may be sequentially dictated by the design software. Further, the erection sequence can also be manifested in the intelligent indicia transferred to each panel component, so as to provide instructions for the individuals erecting the panels. One of skill in the art will understand that the erecting of the panels may be performed during, or in combination with, the present inventive method, or may be achieved after performing the present inventive method.

In one embodiment the present general inventive concept, the assembled and installed panels are optionally inspected by individuals knowledgeable about integrated panelization, as shown at 109. Stated differently, knowledgeable individuals, whether they participated in erecting the panels or not, may examine the installed panels and check for any mistakes, irregularities, inconsistencies, or the like. In one example embodiment, the individuals inspecting the structure may issue a warranty on the installed panels after they successfully pass inspection.

Various example embodiments of the present general inventive concept may also include a system to perform integrated panelization. An integrated panelization system may include a computer having design software installed and operable thereon, in communication with one or more roll formers to fabricate panel components. The computer may receive design parameters for a particular job, and process those parameters using the design software through the software's rule file to make specific, design decisions. The computer may then generate fabrication instructions (using the design software) based on the design decisions and transmit those instructions to one or more roll formers, which may then fabricate the panel components substantially according to the fabrication instructions.

Various example embodiments of the present general inventive concept may employ a single roll former to fabricate all of the panel components, or may use a plurality of roll formers to accomplish the same. In one example embodiment, panel component fabrication may be performed by three roll formers, wherein one roll former produces heavy gauge structural vertical studs in a range of sixty-eight (68) mils to forty-three (43) mils, a second roll former produces all horizontal track members in a range of eighteen (18) mils to sixty-eight (68) mils, and a final roll former used to produce non-structural vertical studs from thirty-three (33) mils to eighteen (18) mils.

In various embodiments, the one or more roll formers may be equipped with one or more modular tool sets to place selected alterations on the individual panel components, which may include interaction options and/or the physical marking of up to all four sides of the panel components with intelligent indicia. Intelligent indicia may include the component's panel designation, a location within the project of the panel that includes the component, the component's location within the panel, markings for the positioning of one or more openings relative to the panel component, and/or information identifying the particular coil spool from which the panel component was fabricated. One of skill in the art will understand that the present general inventive system is not limited to the specific intelligent indicia discussed herein.

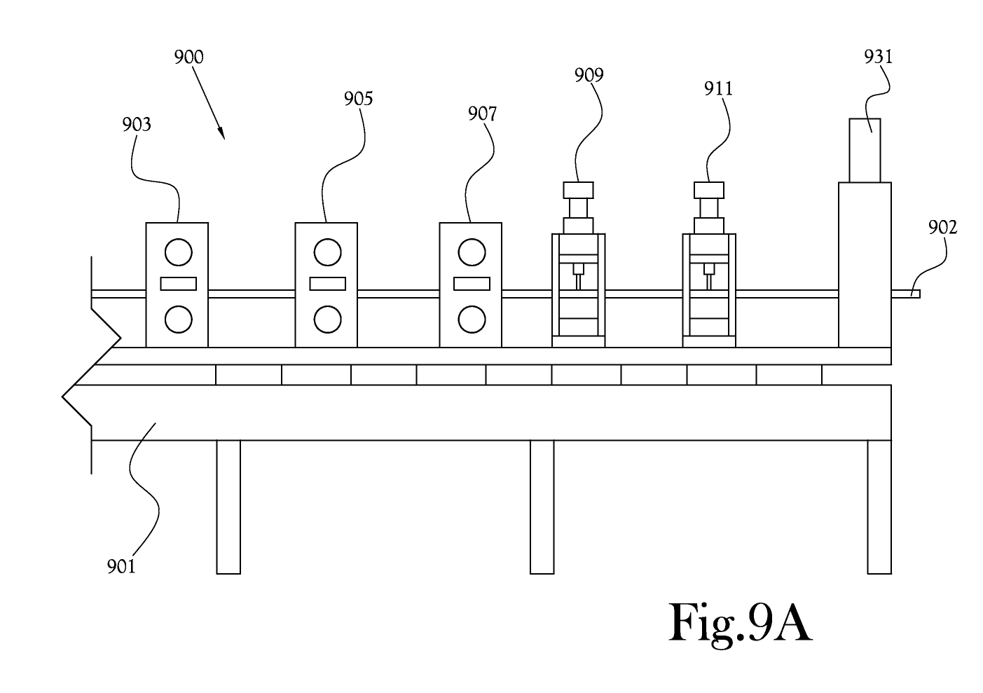

FIG. 8 illustrates a diagram of an example embodiment roll former having modular tool sets installed thereon at selected locations. Modular tool sets may be interchangeable, hydraulic-actuated mechanisms within the roll former that create various shapes, dimples, grooves, markings and other alterations on the individual panel components as they are being fabricated. The modular tool sets may be installed onto the roll former at selected locations using conventional hardware and/or hydraulic fittings. The modular tool sets may be interchangeable with respect to each other, such that they may be installed at a plurality of positions within the roll former, and each modular tool set may be removed and/or replaced by a different modular tool set, as desired by an operator.

For instance, referring to FIG. 8, roll former 800 may begin fabrication of a panel component by receiving a steel coil in one end, as indicated by the directional arrow. The steel coil may first encounter an oiler/tensioner 801 that lubricates the steel coil to aid in the fabrication process. A modular tool set, as indicated at 803, may be positioned adjacent to the oiler/tensioner 801. Modular tool set 803 may be any type of tool set used to alter a panel component during fabrication. One example modular tool set is a circular or triangular index hole punch that is used to place index holes on roof panel components. Another example modular tool set is a dimple punch that is used to place complementary dimples on contiguous panel components. Yet another example modular tool set is a V-shaped groove punch that is used to place V-shaped grooves on contiguous panel components. Modular tool sets may also include one or more print heads that may be used to place physical markings on up to all four sides of selected panel components. Modular tool set 803 is interchangeable and is not required for the roll former to operate. Stated differently, modular tool set 803 may be removed to leave an empty tool envelope without disrupting the function of the other components (forming stations and tool sets) of the roll former 800.

Modular tool sets 803, 805, 823, 825, 827, and 829 may be any type of modular tool set desired to be utilized when fabricating selected panel components. Importantly however, each modular tool set need not be installed in order for the roll former 800 to operate. The roll former 800 may also include any number of forming stations that shape and form the steel coil as it moves through the roll former. Forming stations 805, 807, 809, 811, 813, 815, 817, 821 all shape and form the steel coil as it moves through the roll former and is fabricated into a panel component. The roll former 800 may also include an adjustment station 819 to facilitate any repositioning or adjustment that may be needed as the steel coil moves through the roll former 800 and encounters the various modular tool sets and/or forming stations.

The roll former 800 may also include a shear, or cut-off tool, 831. The shear, or cut-off tool, 831 may be used to correctly size the individual panel components by cutting the steel coil to a specific length once it has been formed and fabricated by the preceding stations and/or modular tool sets of the roll former 800. In one embodiment, the shear 831 is positioned at the end of the roll former.

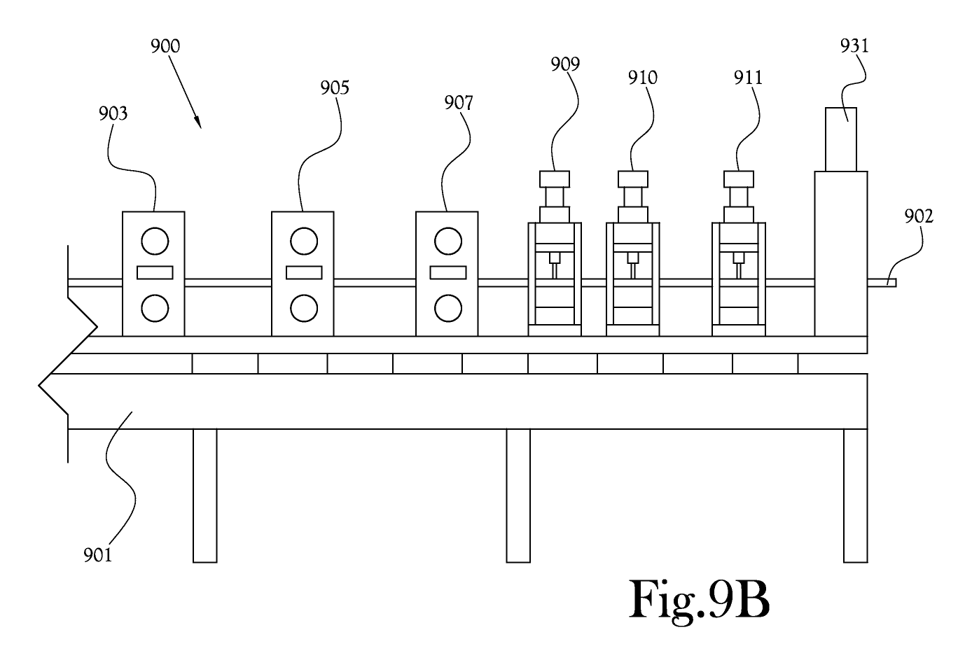

FIG. 9A illustrates a side view of part of an example embodiment roll former 900 having modular tool sets installed thereon at selected locations. The roll former 900 may have a base section 901 whereupon forming stations 903, 905, and 907, modular tool sets 909 and 911, and shear 931 may be installed. In the illustrated embodiment, steel coil 902 travels through the illustrated part of the roll former 900 by moving through forming station 903, forming station 905, and forming station 907, where the steel coil is formed and shaped into the specified dimensions of a particular panel component. Following the illustrated forming stations, the steel coil passes modular tool sets 909 and 911 to receive selected alterations, as determined by the fabrication instructions or an operator via the roll former's control panel (not illustrated). After receiving selected alterations from the illustrated modular tool sets, the steel coil is appropriately sized by the shear, or cut-off tool, 931.

FIG. 9B illustrates a side view of part of the example embodiment roll former of FIG. 9A, but having a different configuration of modular tool sets installed thereon. In the illustrated example embodiment, modular tool set 911 has been repositioned on the roll former 900 to be closer to the shear 931. Modular tool set 909 has remained in the same position as in FIG. 9A. Modular tool set 910 has been added and installed between modular tool sets 909 and 911.

In one example embodiment (not illustrated), all load-bearing vertical studs are fabricated using a single roll former that includes a number of forming stations that are followed by a number of modular tool sets. Stated differently, the roll former that fabricates the load-bearing vertical studs shapes and forms the vertical studs prior to physically altering the components with the modular tool sets. In the same example embodiment, all horizontal tracks are fabricated using a different roll former that includes at least one modular tool set that precedes the forming stations. Stated differently, the horizontal track components may receive alterations prior to being shaped and formed. For instance, the placement of a through-hole 205 on horizontal track 204, as in FIG. 2, must be slightly larger than the dimensions of the vertical stud 203 to be received therethrough. Thus, in one embodiment, the roll former effectuates the through-hole 205 on the steel coil prior to the shaping and forming of the horizontal track 204.

The roll formers may fabricate the panel components at a speed of fewer than 100 feet per minute. In one example embodiment, the roll formers operate at speeds approximately between 60 and 80 feet per minute. Stated differently, the steel coil is fed into the roll former at a rate between 60 and 80 feet per minute and the components are fabricated at a rate between 60 and 80 feet per minute. Conventional fabrication processes frequently occur at speeds greater than 200 feet per minute in order to maximize efficiency. Operating the roll formers at lower speeds, however, will better ensure that the forming stations are accurately shaping and forming the panel components, that the modular tool sets are accurately altering the panel components, and that the shear is accurately sizing the panel components.

In accordance with various embodiments of the present general inventive concept the design parameters received by the computer may include a preferred sequence of installing panels in the project, load requirements of the project, type of panels called for by the project, maximum panel size, location of the panels within the project, and/or the size and location of opening within the project.

Further, using the design software, the computer may process the design parameters to make design decisions. In various example embodiments, the design decisions include the number of panels required by the project, the sizing and number of individual panel components, whether a particular panel will be part of a knockdown kit or a pre-assembled panel, a sequence of fabrication for panel components that is substantially derived from the preferred sequence of panel installation included in the design parameters, and/or the positioning of one or more interaction options on two or more selected, contiguous panel components.

Additionally, fabrication instructions may be generated to direct the one or more roll formers to fabricate the panel components, with the fabrication instructions being substantially derived from the design decisions. In various embodiments the fabrication instructions include the sequence of fabrication, the positioning of one or more interaction options on two or more selected, contiguous panel components, and/or commands for the one or more roll formers to physically mark up to all four sides of the panel components with intelligent indicia.

In various embodiments of the present general inventive system, the one or more roll formers may fabricate the panel components substantially in sequence according to the fabrication instructions. Fabrication may include the placement of one or more interaction options on two or more selected panel components. Fabrication may further include the physical marking of intelligent indicia onto the panel components, using the one or more modular tool sets with multiple print heads on the one or more roll formers. Fabrication may also occur such that the output stream from the roll formers (i.e. panel components) is bifurcated into either components for pre-assembled panels, or components for knockdown kits.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present general inventive concept has been illustrated by description of several example embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

1. A method of producing wall, floor, and/or roof panels, said method comprising:
inputting design parameters for a project into a computer having design software operating thereon;
processing said design parameters by said computer to make design decisions regarding panels and panel components directed to said project;
outputting fabrication instructions from said computer to one or more roll formers for each of said panel components, said fabrication instructions being substantially derived from said design decisions; and
fabricating said panel components by said one or more roll formers according to said fabrication instructions, said fabricating being bifurcated such that selected panel components are fabricated either as a knockdown kit or as a pre-assembled panel grouping.

2. The method of claim 1, further comprising assembling preassembled panels from said selected preassembled panel grouping components.

3. The method of claim 2, further comprising packaging and transferring said selected knockdown kit panel components and said preassembled panels to said project's location.

4. The method of claim 3, further comprising installing said knockdown kit panel components and said preassembled panels at said project location.

5. The method of claim 1, wherein said design parameters include a preferred sequence of panel installation and said design decisions include a sequence of fabrication derived substantially from said preferred sequence of panel installation.

6. The method of claim 1, wherein said design parameters include load requirements of said project, type of panels called for by said project, maximum panel size, location of said panels within said project, size and location of openings within said project, or any combination thereof.

7. The method of claim 1, wherein said design decisions include a positioning of one or more interaction options on selected panel components, said fabrication instructions include said positioning of said one or more interaction options on said selected panel components, and said fabricating said panel components includes placing said one or more interaction options on said selected panel components.

8. The method of claim 7, wherein said one or more interaction options includes complementary dimples, slotted grooves, or a combination thereof.

9. The method of claim 1, wherein said design decisions include designating selected panel components as a knockdown kit or as a preassembled panel grouping.

10. The method of claim 1, wherein said fabricating said panel components by said one or more roll formers includes said one or more roll formers physically marking all four sides of selected panel components with intelligent indicia.

11. The method of claim 9, wherein said intelligent indicia includes said component's panel designation, a location within said project of said panel that includes said component, said component's location within said panel, a positioning of one or more openings in said project relative to said panel component, an identification of a coil spool from which the panel component was fabricated, or any combination thereof.

12. A method of producing a cold-formed steel panel for inclusion into a structural frame, said method comprising:
inputting design parameters for a project into a computer having design software operating thereon, said design parameters including a preferred sequence of installing panels in said project, load requirements of said project, type of panels called for by said project, maximum panel size, location of said panels within said project, size and location of openings within said project, or any combination thereof;
processing, by said computer, said design parameters to make design decisions, said design decisions including a number of panels required by said project, a sequence of fabrication for panel components that is substantially derived from said preferred sequence of panel installation included in said design parameters, said design decisions further including a positioning of one or more interaction options on two or more selected panel components;
outputting fabrication instructions from said computer to one or more roll formers, said fabrication instructions being substantially derived from said design decisions, said fabrication instructions including said sequence of fabrication, said positioning of said one or more interaction options on said two or more selected panel components, commands for said one or more roll formers to physically mark all four sides of selected panel components with intelligent indicia, or any combination thereof;
fabricating said panel components by said one or more roll formers, said fabrication occurring substantially in sequence according to said fabrication instructions and including placing said one or more interaction options on said two or more selected panel components and said physical marking of intelligent indicia onto said all four sides of said selected panel components; and
assembling said panel components to form a panel such that assembly is performed in sequence substantially according to said sequence of fabrication, and contiguous panel components are engaged by a mating said interaction options.

13. The method of claim 12, wherein said intelligent indicia includes said panel component's panel designation, a location within said project of said panel that includes said component, said panel component's location within said panel, a positioning of one or more openings relative to said panel component, an identification of a coil spool from which the panel component was fabricated, or any combination thereof.

14. The method of claim 12, wherein said computer processing said design parameters to make said design decisions includes determining whether said panel components are to be fabricated as part of a knockdown kit or as part of a preassembled panel grouping, said outputting said fabrication instructions to said one or more roll formers includes designating each said panel component to be fabricated as part of a knockdown kit or as part of a pre-assembled panel grouping, said fabricating said panel components includes bifurcating fabrication such that said panel components are selectively fabricated either as part of a knockdown kit or as a preassembled panel grouping.

15. A system to produce wall, floor, and/or roof panels, said system comprising:
a computer having design software installed and operable thereon to control said computer to receive design parameters for a project, process said design parameters using said design software to make design decisions, and generate fabrication instructions substantially according to said design decisions; and
one or more roll formers to fabricate panel components, said one or more roll formers in communication with said computer to receive said fabrication instructions from said design software, said one or more roll formers fabricating said panel components substantially according to said fabrication instructions, said one or more roll formers including one or more modular tool sets that selectively alter selected panel components according to said fabrication instructions.

16. The system of claim 15, wherein said computer receives design parameters for said project, said parameters including a preferred sequence of installing panels in said project, load requirements of said project, type of panels called for by said project, maximum panel size, location of said panels within said project, size and location of openings within said project, or any combination thereof.

17. The system of claim 15, wherein said computer processes said design parameters to make design decisions, said design decisions including a number of panels required by said project, a sequence of fabricating said panel components that is substantially derived from said preferred sequence of panel installation included in said design parameters, said design decisions further including a positioning of one or more interaction options on two or more selected panel components.

18. The system of claim 15, wherein said fabrication instructions are substantially derived from said design decisions, said fabrication instructions including said sequence of fabrication, said positioning of said one or more interaction options on said two or more selected panel components, commands for said one or more roll formers to physically mark all four sides of selected panel components with intelligent indicia, or any combination thereof.

19. The system of claim 18, wherein said intelligent indicia includes said component's panel designation, a location within the project of said panel that includes said component, said component's location within said panel, a positioning of one or more openings relative to said panel component, an identification of a coil spool from which the panel component was fabricated, or any combination thereof.

20. The system of claim 19, wherein said roll former includes one or more modular tool sets with a dimpling punch to place dimples on selected panel components, one or more modular tool sets with a V-shaped punch to place slotted grooves on selected panel components, and one or more modular tool sets with two or more print heads to physically mark all four sides of selected panel components with said intelligent indicia, said one or more modular tool sets being interchangeable with one another.
